(19) United States
(12) Patent Application Publication
(10) Pub. No.: US 2021/0360507 A1
(43) Pub. Date: Nov. 18, 2021

(54) COMMUNICATION SYSTEM AND ANTENNA INSTALLATION METHOD

(71) Applicant: Mitsubishi Electric Corporation, Tokyo (JP)

(72) Inventor: Hiroshi NISHIMOTO, Tokyo (JP)

(73) Assignee: Mitsubishi Electric Corporation, Tokyo (JP)

(21) Appl. No.: 17/386,405

(22) Filed: Jul. 27, 2021

Related U.S. Application Data
(63) Continuation of application No. PCT/JP2019/013900, filed on Mar. 28, 2019.

(51) Int. Cl. H04W 40/20; H04L 12/733; H04W 40/38

(52) U.S. Cl. CPC H04W 40/20; H04W 40/38; H04L 45/20; H04L 45/122

(57) ABSTRACT

In a communication system that performs multihop wireless transmission between radio stations arranged at intervals, allocation of a same channel is repeated every odd-number of hops among a plurality of consecutive hops, and reception antennas and transmission antennas for radio signals relayed by the radio stations are installed at such positions that transmission paths of the radio signals have zigzag shapes.

### CROSS-REFERENCE TO RELATED APPLICATION

This application is a continuation application of International Application PCT/JP2019/013900, filed on Mar. 28, 2019, and designating the U.S., the entire contents of which are incorporated herein by reference.

### BACKGROUND OF THE INVENTION

### 1. Field of the Invention

The disclosure relates to a communication system and an antenna installation method for multihop transmission between radio stations.

### 2. Description of the Related Art

For building new radio communication infrastructure, it has conventionally been necessary to build wire communication facilities using optical fibers and the like for backhaul between radio stations and between radio stations and a core network. In contrast, multihop wireless transmission can eliminate the need for wired systems between communication stations.

Secured transmission capacity is important for backhaul. In a case where wireless multihop is applied to achieve backhaul, a wide transmission bandwidth is also necessary, and a high-frequency band such as a millimeter-wave band is suitable for securing a wide band. Japanese Patent Application Laid-open No. 2002-305474 describes an example of a communication system that performs radio communication using a millimeter-wave band, which, however, differs from examples of application to backhaul.

Note that high-frequency bands such as a millimeter-wave band have the characteristics of a high propagation loss and a high propagation straightness. Thus, in radio communication using a high-frequency band, typically, directional antennas with high gain for transmission and reception are directed to each other, so that the channel quality is ensured.

In a case where multihop wireless transmission in a high-frequency band is applied to achieve backhaul, a radio station including a transmission antenna and a reception antenna constitutes one station installation set, a plurality of station installation sets are arranged linearly at intervals, and radio transmission is performed between adjacent station installation sets. In each station installation set, the reception antenna receives data transmitted from an adjacent station installation set, the radio station performs a relay process on the received data, and the transmission antenna then transmits the data in a direction opposite the direction from which the data are received.

In addition to the transmission capacity, high reliability is also required of the backhaul. In the case where multihop wireless transmission is applied to achieve the backhaul, wireless channel allocation is important so as to ensure high reliability. Note that a channel refers to an independent radio resource for performing radio communication without interference. In a case where time division multiple access (TDMA) is applied, time is divided into a plurality of slots, and one slot is used as one channel for transmission between hops. In a cases where frequency division multiple access (FDMA) is applied, a frequency band is divided into a plurality of sub-bands, and one sub-band is used as one channel for transmission between hops. Alternatively, code division multiple access (CDMA) can also be applied.

In any of the cases where the aforementioned techniques are applied, however, allocation of different channels depending on the hops lowers the transmission capacity per hop, and it is therefore desirable to repetitively allocate the same channel to a plurality of hops that are geographically at some distance from each other. In a case where multihop wireless transmission is performed between radio stations that are arranged linearly at intervals, however, a signal transmitted toward an intended adjacent radio station may impose interference to a distant hop using the same channel. In the present specification, the co-channel interference will be referred to as inter-hop interference. For example, in a case where allocation of one channel is repeated every two hops, a radio signal transmitted over a hop reaches another hop that is two hops away, which causes inter-hop interference. This is also applicable to cases where allocation of one channel is repeated every three or more hops. In a case where inter-hop interference is large, there is a problem in that the communication channel quality the hop is degraded, and the transmission capacity or the reliability thereof is lowered.

### SUMMARY OF THE INVENTION

In order to solve the above-mentioned problem and achieve the object, a communication system according to the present disclosure performs multihop wireless transmission between radio stations arranged at intervals. Allocation of a same channel is repeated every odd-number of hops among a plurality of consecutive hops, and reception antennas and transmission antennas for radio signals relayed by the radio stations are installed at such positions that transmission paths of the radio signals have zigzag shapes.

### BRIEF DESCRIPTION OF THE DRAWINGS

FIG. 1 is a diagram illustrating an example of a configuration of a communication system according to an embodiment;

FIG. 2 is a graph illustrating an example of a directivity pattern of a transmission antenna and a reception antenna included in a station installation set in the communication system according to the embodiment;

FIG. 3 is a diagram illustrating an example of installation of a transmission antenna included in a station installation set in the communication system according to the embodiment;

FIG. 4 is a diagram illustrating an example of installation of a reception antenna included in a station installation set in the communication system according to the embodiment;

FIG. 5 is a diagram illustrating an example of channel allocation in the communication system according to the embodiment; and

FIG. 6 is a diagram illustrating another example of channel allocation in the communication system according to the embodiment.

### DETAILED DESCRIPTION OF THE PREFERRED EMBODIMENTS

A communication system and an antenna installation method according to an embodiment of the present disclosure will be described in detail below with reference to the drawings.

### Embodiment

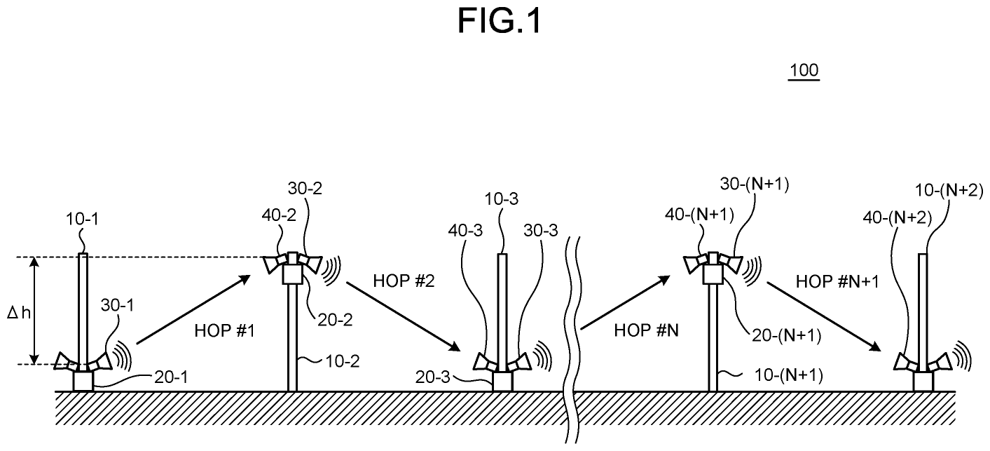

FIG. 1 is a diagram illustrating an example of a configuration of a communication system according to an embodiment. The communication system according to the embodiment is a communication system that applies wireless multihop to achieve a backhaul. Hereinafter, a backhaul achieved by the communication system according to the embodiment will be referred to as a wireless multihop backhaul.

The communication system 100 is constituted by radio stations 20-n (n=1, 2, 3, . . . ), transmission antenna 30-n, and reception antennas 40-n, each mounted on a corresponding one of a plurality of supports 10-n arranged linearly at intervals. A radio station 20-n, a transmission antenna 30-n, and a reception antenna 40-n that are mounted on one support 10-n constitute one station installation set. The transmission antenna 30-n is mounted on the support 10-n so as to radiate radio waves in a direction toward a position at which a radio station 20-(n+1) is installed. The reception antenna 40-n is mounted on the support 10-n so as to receive radio waves in a direction from a position at which a radio station 20-(n−1) is installed.

In each station installation set, data received by the reception antenna 40-n is subjected to a relay process in the radio station 20-n, and then retransmitted by the transmission antenna 30-n. Over a hop #n, a signal is transmitted from the transmission antenna 30-n and received by the reception antenna 40-(n+1).

In addition, as illustrated in FIG. 1, in the communication system 100, the transmission antennas 30-n and the reception antennas 40-n are installed alternately at high positions and low positions in a zigzag manner in units of the station installation sets. Thus, the transmission path of a radio signal relayed by the station installation sets has a zigzag shape. In addition, the transmission path of a radio signal relayed by the station installation sets is formed in a plane perpendicular to the ground. In the present embodiment, a height difference between installation positions of the individual station installation sets will be represented by Δh. Note that the height difference Δh corresponds to a distance between a first line and a second line, where the first line is a line connecting station installation sets that perform odd-numbered relays, and the second line is a line connecting station installation sets that perform even-numbered relays and parallel to the first line. Hereinafter, effects and installation conditions in the case where the transmission antennas 30-n and the reception antennas 40-n in the station installation sets are installed in a zigzag manner as illustrated in FIG. 1 will be explained.

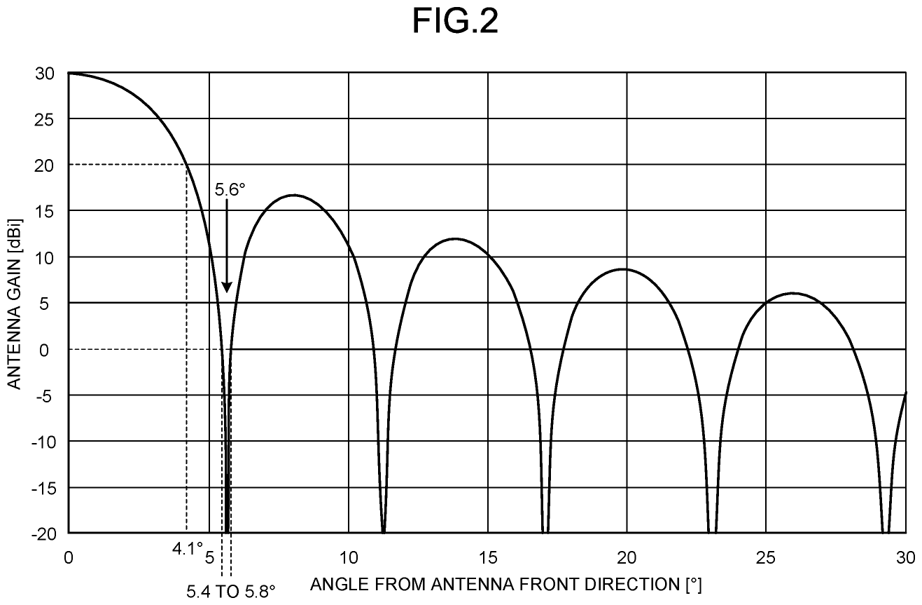

FIG. 2 is a graph illustrating an example of a directivity pattern of antennas used as a transmission antenna and a reception antenna of a station installation set in the communication system according to the embodiment. In FIG. 2, the horizontal axis represents the angle from a front direction, and the vertical axis represents antenna gain. Herein, the antenna gain in the front direction, that is, the directive gain is assumed to be 30 dBi. In addition, a one-side half-power angle is assumed to be 2.5°. For example, on the assumption that interference can be sufficiently reduced when the antenna gain in a direction of inter-hop interference is equal to or smaller than 0 dBi, which is a first threshold, and that an applicable angle is represented by θ₁, a one-side angle range thereof is 5.4°≤θ₁≤5.8°. Although an angle range of 10.9° to 11.7° is also equal to or smaller than 0 dBi, the former angle range, which is a null range between a main lobe and a side lobe, is used. Thus, when θ₁=5.4°, for example, and when the antenna installation angle is tilted upward or downward by 5.4° with respect to the horizontal direction, the antenna gain in the horizontal direction is equal to or smaller than 0 dBi, and thus, a transmission antenna can reduce the interference power at a distance reception antenna subject to inter-hop interference, or a reception antenna can reduce inter-hop interference coming a long distance before reception.

In contrast, on the assumption that the antenna gain necessary for transmission and reception is 20 dBi, which is a second threshold and that an applicable angle is represented by θ₂, a one-side angle range to achieve line-of-sight between transmitting and receiving ends is 0°≤θ₂≤4.1°. In order to achieve both of directing the antenna directivity angle θ₁ at which the interference can be reduced as described above to the horizontal direction and making transmitting and receiving ends face each other at the antenna directivity angle θ₂ at which a high gain is obtained, the heights at which the antennas are installed need to be alternately high and low in a zigzag manner in units of station installation sets as illustrated in FIG. 1.

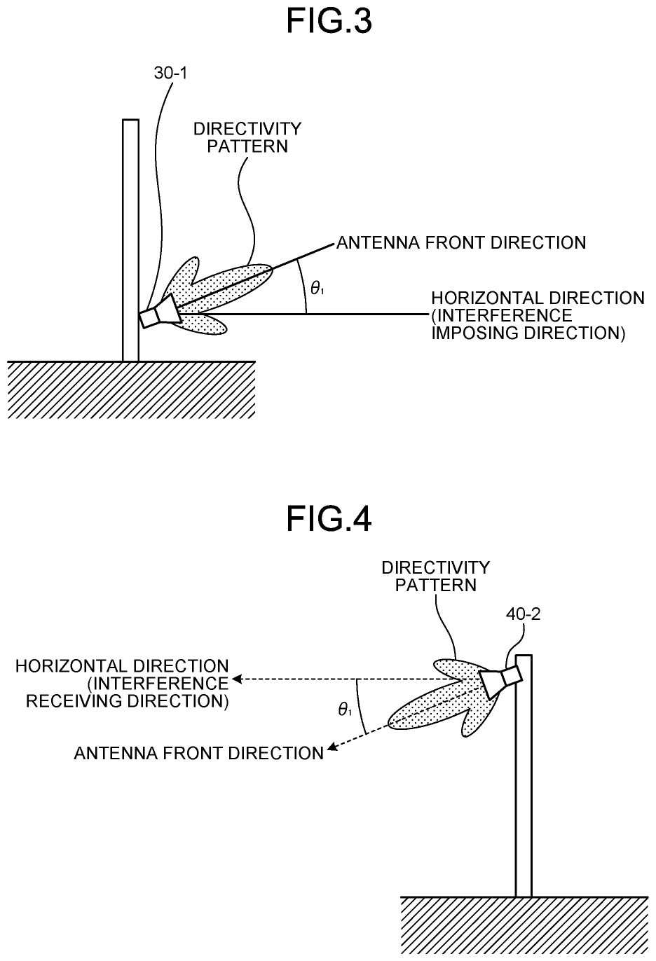

FIG. 3 is a diagram illustrating an example of installation of a transmission antenna included in a station installation set in the communication system according to the embodiment. FIG. 3 illustrates the transmission antenna 30-1 extracted from FIG. 1 with a directivity pattern. The transmission antenna 30-1 is installed at a small height, that is, at a low position, the antenna installation angle (tilt angle) thereof is set, as θ₁ described above, upward with respect to the horizontal direction, and a null is directed to the horizontal direction.

FIG. 4 is a diagram illustrating an example of installation of a reception antenna included in a station installation set in the communication system according to the embodiment. FIG. 4 illustrates the reception antenna 40-2 extracted from FIG. 1 with a directivity pattern. The reception antenna 40-2 is installed at a large height, the tilt angle thereof is set, as θ₁ described above, downward with respect to the horizontal direction, and a null is directed to the horizontal direction in a manner similar to the transmission antenna 30-1 illustrated in FIG. 3.

In an example, when the antenna tilt angle is θ₁=5.4° and the direction in which transmitting and receiving ends have line-of-sight with each other is θ₂=4.1° from the antenna front direction, a necessary height difference between the station installation sets when the inter-hop distance d is 200 m is Δh=d×tan(|θ₁−θ₂|)=200×tan(5.4°−4.1°)=4.5 m. Note that the inter-hop distance d herein refers to the distance between a support 10-n and a support 10-(n+1) adjacent to each other, that is an installation interval. In addition, when the direction in which transmitting and receiving ends are oriented to each other is referred to as the antenna front direction, the height difference to be set when the inter-hop distance is 200 m is Δh=200×tan(5.4°)=18.9 m. The height difference Δh may therefore be set between 4.5 m and 18.9 m. While the directional antenna is assumed to be an antenna with a one-side half-power angle of 2.5° having the characteristics illustrated in FIG. 2 herein, the difference between θ₁ and θ₂ can be set to be smaller with a narrow directional antenna having a smaller one-side half-power angle, which can reduce the height difference Δh.

Next, channel allocation for reducing inter-hop interference in antenna station installation in the zigzag manner described above will be explained. When a transmission antenna is tilted upward at a low position, it is desirable that an intended reception antenna be tilted downward at a high position, but it is desirable that a reception antenna that receives interference be tilted upward at a low position in a manner similar to the transmission antenna that imposes interference. In addition, when a transmission antenna is tilted downward at a high position, it is desirable that an intended reception antenna be tilted upward at a low position, but it is desirable that a reception antenna that receives interference be tilted downward at a high position in a manner similar to the transmission antenna that imposes interference.

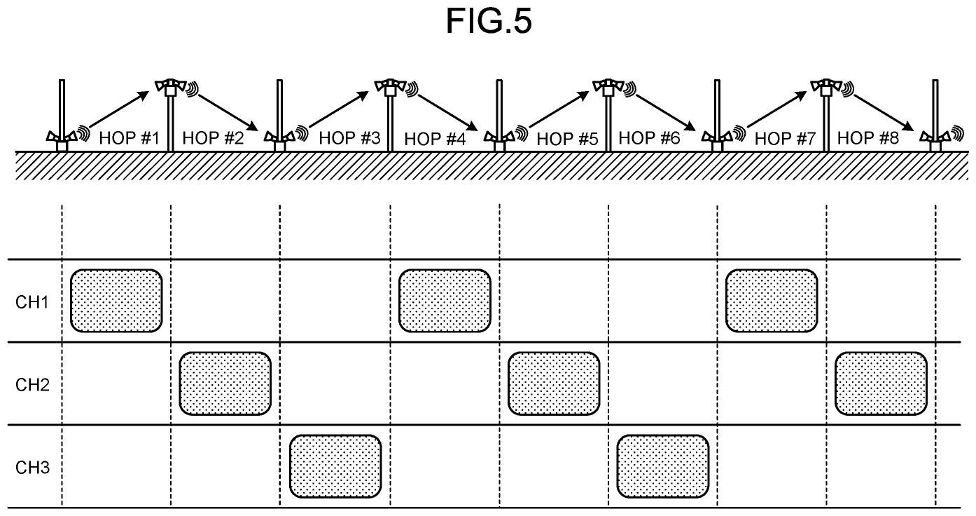

In order to meet the aforementioned condition, channel allocation needs to be repeated every odd-number of hops. FIG. 5 is a diagram illustrating an example of channel allocation in the communication system according to the embodiment. FIG. 5 illustrates a state of channel allocation to the individual hops in a case where allocation of one channel is repeated every three hops. In this case, the same channel as a hop #1 is allocated to a hop #4, for example, and the hop #4 is therefore likely to receive inter-hop interference. Because, however, the transmission antenna of the hop #1 and the reception antenna of the hop #4 are both tilted upward at low positions, the hop #4 is less likely to receive inter-hop interference. In addition, the same channel as a hop #2 is allocated to a hop #5, and the hop #5 is therefore similarly likely to receive inter-hop interference. Because, however, the transmission antenna of the hop #2 and the reception antenna of the hop #5 are both tilted downward at high positions, the hop #5 is less likely to receive inter-hop interference.

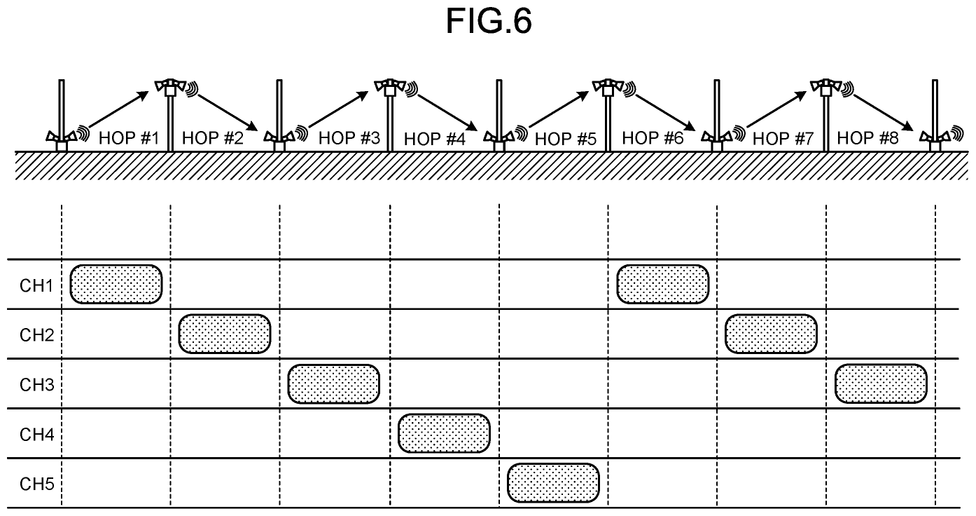

FIG. 6 is a diagram illustrating another example of channel allocation in the communication system according to the embodiment. FIG. 6 illustrates a state of channel allocation to the individual hops in a case where allocation of one channel is repeated every five hops. In this case, because the same channel as a hop #1 is allocated to a hop #6, for example, the hop #6 is likely to receive inter-hop interference, but because the transmission antenna of the hop #1 and the reception antenna of the hop #6 are both tilted upward at low positions, the hop #6 is less likely to receive inter-hop interference.

As described above, in the communication system 100 according to the present embodiment, the station installation sets each constituted by a radio station, a transmission antenna, and a reception antenna are arranged at intervals, and multihop wireless transmission is performed between the station installation sets. In addition, in the communication system 100, the heights (positions) at which the antennas are installed are alternately high and low in a zigzag manner in units of station installation sets, and allocation of one channel is repeated every odd-number of hops. This enables reduction in inter-hop interference, which can improve the channel quality, and also enables repetitive allocation of a channel, which can ensure sufficient channel capacity.

While an example of a method of installing antennas at different heights from those in adjacent station installation sets in a zigzag manner within a plane perpendicular to the ground is presented in the present embodiment, the installation is not limited thereto. Because it is sufficient, in order to reduce inter-hop interference, that a null of the antenna directivity is directed to a direction of inter-hop interference and that a direction in which a required gain can be obtained is directed to an intended transmitting/receiving direction, the antennas may be installed at the same height in a zigzag manner within a horizontal plane, that is, within a plane (horizontal plane) parallel to the ground, and the transmission antennas and the reception antennas may be tilted within the horizontal plane.

A communication system according to the present disclosure produces an effect of enabling improvement in the communication channel quality of multihop wireless transmission.

The configurations presented in the embodiment above are examples, and can be combined with other known technologies or can be partly omitted or modified without departing from the gist.

What is claimed is:

1. A communication system to perform multihop wireless transmission between repeaters arranged at intervals, wherein
allocation of odd-number of channels is repeated every hops among a plurality of consecutive hops, and
reception antennas and transmission antennas for radio signals relayed by the repeaters are installed at such positions that transmission paths of the radio signals have zigzag shapes, wherein
the reception antennas are each installed with a front direction thereof directed to a position where a transmission antenna being a transmission source of a radio signal to be received is installed, the front direction being a direction in which a maximum antenna gain is obtained, and
the transmission antennas are each installed with a front direction thereof directed to a position where a reception antenna to receive a radio signal to be transmitted is installed, the front direction being a direction in which a maximum antenna gain is obtained, and wherein
each of repeaters to perform odd-numbered relays is installed on a first line, and each of repeaters to perform even-numbered relays is installed on a second line parallel to the first line, and
when an angle of the reception antennas and the transmission antennas with respect to a front direction in a case where antenna gains of the reception antennas and the transmission antennas are equal to or smaller than a first threshold is represented by θ₁,
the reception antennas and the transmission antennas are installed in a manner that an angle between the front direction and the first line or the second line is θ₁.

2. The communication system according to claim 1, wherein
the reception antennas and the transmission antennas are installed at such positions that the transmission paths of the radio signals are zigzag within a plane perpendicular to a ground.

3. The communication system according to claim 1, wherein
the reception antennas and the transmission antennas are installed at such positions that the transmission paths of the radio signals are zigzag within a plane parallel to a ground.

4. The communication system according to claim 1, wherein
when a distance between adjacent repeaters in a direction parallel to the first line and the second line is represented by d and an angle between a direction in which antenna gains of the reception antennas and the transmission antennas are equal to or larger than a second threshold and the front direction of the reception antennas and the transmission antennas is represented by θ₂,
a distance between the first line and the second line is equal to or larger than d×tan(|θ₁−θ₂|).

5. The communication system according to claim 2, wherein
when a distance between adjacent repeaters in a direction parallel to the first line and the second line is represented by d and an angle between a direction in which antenna gains of the reception antennas and the transmission antennas are equal to or larger than a second threshold and the front direction of the reception antennas and the transmission antennas is represented by θ₂,
a distance between the first line and the second line is equal to or larger than d×tan(|θ₁−θ₂|).

6. The communication system according to claim 3, wherein
when a distance between adjacent repeaters in a direction parallel to the first line and the second line is represented by d and an angle between a direction in which antenna gains of the reception antennas and the transmission antennas are equal to or larger than a second threshold and the front direction of the reception antennas and the transmission antennas is represented by θ₂,
a distance between the first line and the second line is equal to or larger than d×tan(|θ₁−θ₂|).

7. An antenna installation method for a communication system to perform multihop wireless transmission between repeaters arranged at intervals, the antenna installation method comprising:
installing reception antennas and transmission antennas for radio signals relayed by the repeaters at such positions that transmission paths of the radio signals have zigzag shapes, wherein
the reception antennas are each installed with a front direction thereof directed to a position where a transmission antenna being a transmission source of a radio signal to be received is installed, the front direction being a direction in which a maximum antenna gain is obtained, and
the transmission antennas are each installed with a front direction thereof directed to a position where a reception antenna to receive a radio signal to be transmitted is installed, the front direction being a direction in which a maximum antenna gain is obtained, and
wherein
each of repeaters to perform odd-numbered relays is installed on a first line, and each of repeaters to perform even-numbered relays is installed on a second line parallel to the first line, and
when an angle of the reception antennas and the transmission antennas with respect to a front direction in a case where antenna gains of the reception antennas and the transmission antennas are equal to or smaller than a first threshold is represented by θ₁, the reception antennas and the transmission antennas are installed in a manner that an angle between the front direction and the first line or the second line is θ₁.

8. The antenna installation method according to claim 7, wherein
the reception antennas and the transmission antennas are installed at such positions that the transmission paths of the radio signals are zigzag within a plane perpendicular to a ground.

9. The antenna installation method according to claim 7, wherein
the reception antennas and the transmission antennas are installed at such positions that the transmission paths of the radio signals are zigzag within a plane parallel to a ground.

10. The antenna installation method according to claim 7, wherein
when a distance between adjacent repeaters in a direction parallel to the first line and the second line is represented by d and an angle between a direction in which antenna gains of the reception antennas and the transmission antennas are equal to or larger than a second threshold and the front direction of the reception antennas and the transmission antennas is represented by θ₂,
a distance between the first line and the second line is equal to or larger than d×tan(|θ₁−θ₂|).

11. The antenna installation method according to claim 8, wherein
when a distance between adjacent repeaters in a direction parallel to the first line and the second line is represented by d and an angle between a direction in which antenna gains of the reception antennas and the transmission antennas are equal to or larger than a second threshold and the front direction of the reception antennas and the transmission antennas is represented by θ₂,
a distance between the first line and the second line is equal to or larger than d×tan(|θ₁−θ₂|).

12. The antenna installation method according to claim 9, wherein
when a distance between adjacent repeaters in a direction parallel to the first line and the second line is represented by d and an angle between a direction in which antenna gains of the reception antennas and the transmission antennas are equal to or larger than a second threshold and the front direction of the reception antennas and the transmission antennas is represented by θ₂,
a distance between the first line and the second line is equal to or larger than d×tan(|θ₁−θ₂|).
